(19) United States
(12) Patent Application Publication
(10) Pub. No.: US 2012/0128113 A1
(43) Pub. Date: May 24, 2012

(54) REMOTE CONTROL SYSTEM FOR THE FUEL HANDLING SYSTEM OF NUCLEAR POWER PLANT

(76) Inventors: Byeong Taek PARK, Changwon-si (KR); Suk Hwan Jung, Seoul (KR)

(21) Appl. No.: 13/243,791

(22) Filed: Sep. 23, 2011

(30) Foreign Application Priority Data
Nov. 22, 2010 (KR) 10-2010-0115992

(51) Int. Cl. G21C 19/19; G21C 19/07; G21C 19/02

(52) U.S. Cl. 376/264; 376/261

(57) ABSTRACT

Disclosed is a remote control system for a fuel handling system of a nuclear power plant, in which the system includes a remote control console; a programmable logic controller (PLC) unit; a servo motor drive; and a human-machine interface (HMI) unit.

### BACKGROUND OF THE INVENTION

1. Field of the invention

The present invention relates to a control system of a refueling machine and a spent fuel handling machine, in which the machines transfer nuclear fuel and load and extract the nuclear fuel to/from a reactor in a nuclear power plant.

2. Description of the Prior Art

In a conventional control system for a refueling machine and a spent fuel handling machine, a control console is provided above the machine. The refueling machine is operated above a reactor pool above a nuclear reactor, that is, a high radioactivity area in order to extract and load fuel from/to the nuclear reactor, and the spent fuel handling machine is operated above a spent fuel storage pool for storing spent fuel, that is, a highly radioactive material. In order to shield radioactivity, the uppermost part of spent fuel extracted from a nuclear reactor is transferred under a predetermined depth (e.g. 2.4 m) within a boric acid solution, and also spent fuel of a spent fuel storage rack is transferred under a predetermined depth (e.g. 2.4 m) within a boric acid solution.

FIG. 1 is a plan view illustrating machines for a fuel handling system within a nuclear reactor building of a nuclear power plant currently in operation.

As shown, a fuel handling system within a nuclear reactor building includes a reactor 11, a reactor pool 12, a refueling machine 13, a refueling machine trolley 14, a refueling machine control console 15, a fuel transfer system (FTS) 16, and a FTS control console 17.

The fuel handling system loads new fuel to the reactor 11 by using the refueling machine 13 and extracts and transfers spent fuel to the FTS 16, and then the FTS 16 transfers the spent fuel from a reactor building to a fuel building.

In order to change fuel within the reactor 11, a reactor cover is opened, and an upper structure within the reactor is disassembled from the reactor 11. When the cover of the reactor 11 and the upper structure within the reactor are removed, highly radioactive spent fuel is exposed. Herein, when a boric acid solution used for shielding radioactivity is fully filled in a reactor pool, nuclear fuel is positioned under a predetermined depth (e.g. about 15 m) from the surface of the liquid.

In order to transfer nuclear fuel, the refueling machine 13 provided in the reactor pool 12 is used to lift the fuel by about 10 m, to extract it from the reactor 11, and to transfer it to the FTS 16 through horizontal movement. Herein, an operator of a nuclear fuel handling system, at a position above the reactor 11, operates the control console 15 provided in the refueling machine trolley 14, so that the nuclear fuel positioned under a predetermined depth (e.g. about 15 m) from the surface of the liquid can be grappled and lifted by a grapple of the nuclear fuel handling system.

FIG. 2 is a plan view illustrating machines for a fuel handling system within a nuclear fuel building of a nuclear power plant currently in operation.

As shown, a fuel handling system within the nuclear fuel building includes a spent fuel storage rack 21, a spent fuel handling machine (SFHM) 22, an SFHM trolley 23, an SFHM control console 24, an FTS 25, an FTS control console 26, and a spent fuel storage pool 27.

The fuel handling system within the nuclear fuel building lifts the spent fuel (transferred from the reactor building to the FTS 25) by a predetermined distance (e.g., about 5 m) from the FTS 25, and extracts it by using the SFHM 22 provided above the spent fuel storage pool 27. Then, the fuel handling system horizontally transfers the spent fuel to the spent fuel storage rack 21, and loads the spent fuel to the spent fuel storage rack 21 by lowering it again by a predetermined distance (e.g. about 5 m).

The spent fuel storage rack 21, which is an apparatus for storing highly radioactive spent fuel before being transferred to a permanent storage apparatus, uses a boric acid solution for shielding radioactivity. Herein, the boric acid solution is fully filled in the spent fuel storage pool 27, and the spent nuclear fuel is positioned under a predetermined depth (e.g. about 10 m) from the surface of the liquid.

In a fuel building of a nuclear power plant, an operator of the SFHM 22 operates the SFHM control console 24 of the SFHM trolley 23 provided above the spent fuel storage pool 27 so that a spent fuel handling tool is grappled by a hook of the SFHM 22 and a fuel grapple of the handling tool grapples nuclear fuel. Then, the spent fuel is loaded and stored to/in the spent fuel storage rack 21 positioned under a predetermined depth (e.g. 10 m) from the surface of the liquid. The operator loads and charges the nuclear fuel while monitoring if the nuclear fuel is accurately engaged with the grapple with his naked eye.

As described above, the operation position of an operator has been conventionally above a reactor, that is, a highly radioactive area, and above the spent fuel storage rack 21 storing spent fuel, that is, a highly radioactive material. In other words, the operator performs an operation for a long time at a position above a highly radioactive material, although the operation performance position is above the radioactivity-shielded surface of the liquid. Thus, there is a problem in that he can be affected by radioactivity.

Also, since the operator repeatedly enters and leaves the position above the highly radioactive reactor 11 and the highly radioactive spent fuel storage rack 21 to carry out an operation, there still exist dangerous factors on the operator, such as a physical danger, the falling of foreign substances.

Accordingly, it is required to develop an apparatus which can reduce the operator's exposure to radioactivity in the above described highly radioactive environment, and fundamentally prevent the operator himself or a foreign object from falling which would be crucially disadvantageous in the operation of the reactor.

### SUMMARY OF THE INVENTION

Accordingly, the present invention has been made to solve the above-mentioned problems occurring in the prior art, and the present invention provides a control system of a nuclear power plant, which can reduce an operator's exposure to radioactivity in a highly radioactive environment, and fundamentally prevent the operator himself or a foreign object from falling which would be crucially disadvantageous in the operation of a reactor.

In order to achieve the object, in the present invention, a control console is not provided directly in a machine so as to fundamentally prevent exposure to radioactivity or the dropping of foreign substances. In other words, a control console of a refueling machine is provided at the lateral side of a reactor pool so that it can be operated, and a control console of a spent fuel handling machine is provided at the lateral side of a spent fuel storage pool. Thus, high radioactivity emanating from the upper side of a reactor or a spent fuel storage rack can have a minimized affect on an operator.

In accordance with an aspect of the present invention, there is provided a remote control system for a fuel handling system of a nuclear power plant, the remote control system including a remote control console for controlling the fuel handling system in a remote location, wherein the remote control console includes: a programmable logic controller (PLC) unit which provides a control logic for operation to the fuel handling system, receives a signal input from a sensor provided in the fuel handling system, and transmits a signal for driving the fuel handling system; a servo motor drive which supplies driving power to a servo motor for driving the fuel handling system and controls a speed by receiving a signal from the PLC unit; and a human-machine interface (HMI) unit disposed in a remote location from the fuel handling system provides a user interface so that an operation status of the fuel handling system is displayed based on the sensor's signal received from the PLC unit, and a signal input from an operator is transferred to the PLC unit.

When the fuel handling system includes a reactor, a reactor pool, a fuel transfer system (FTS), and a refueling machine which loads new fuel to the reactor, and extracts and transfers spent fuel to the FTS, the remote control console is provided at a lateral side of the reactor pool, instead of above the reactor.

Also, when the fuel handling system includes a spent fuel storage rack, a spent fuel storage pool, an FTS, and a spent fuel handling machine which extracts spent fuel from the FTS, and transfers and loads the spent fuel to the spent fuel storage rack, the remote control console is provided at a lateral side of the spent fuel storage pool, instead of above the spent fuel storage rack.

Also, the PLC unit stores the operator's input command value of a location (or a speed) of the fuel handling system, generates in real-time a signal required to reach the command value by comparing the command value to the fuel handling system's location (or speed)'s value detected in real-time from the sensor provided in the fuel handling system, and transfers the signal to the servo motor drive.

Also, the control system according to the present invention further includes a photographing device which photographs in real-time a state where a fuel grapple grapples fuel in the fuel handling system, and provides the photographed state as an image signal to the HMI unit so that the HMI unit can display in real-time the state where the fuel grapple grapples the fuel.

Also, according to the present invention, the user interface of the HMI unit is operated through a touch screen, and the touch screen and a calculation part for driving the HMI unit are integratedly formed without internal wiring therebetween.

Also, according to a preferred embodiment, the user interface of the HMI unit is divided into one area for displaying in real-time an operation status of the fuel handling system, and another area for displaying a touch menu allowing functions of the fuel handling system to be performed.

According to the present invention, a control console is not provided directly in a machine so as to fundamentally prevent exposure to radioactivity or the dropping of foreign substances. A control console of a refueling machine is provided at the lateral side of a reactor pool so that it can be operated, and a control console of a spent fuel handling machine is provided at the lateral side of a spent fuel storage pool. Thus, high radioactivity emanating from the upper side of a reactor or a spent fuel storage rack can have a minimized affect on an operator.

For such a remote operation, the control system according to the present invention includes a PLC unit and an HMI unit. Also, the operation status of a fuel handling system is transmitted to a control console through an encoder provided in a driving part. The control console allows an input signal to be displayed on an operation screen so that an operator can exactly sense the signal.

Also, the system according to the present invention employs a human machine interface system which is developed to allow an operator to easily carry out operation through an operation screen. A state where a grapple of a machine grapples fuel is transmitted to a control console by using a TV camera. Then, while the grapple upwardly extracts the fuel from a reactor, a change of a load added to the grapple, and a movement location of the grapple are sensed. Accordingly, the entire operation status of the machine can be displayed in the control console, so that the operator even in a remote location can operate the machine through the same information as that of the operation above the machine.

The HMI unit according to the present invention is preferably realized in such a manner that the user's operation can be carried out through a touch screen. Through the operation via the touch screen, an operator can make an operation instruction according to an automatic operation process. Thus, it is possible to simply carry out an operation, and to quickly obtain nuclear fuel transfer information.

Also, in the HMI unit according to the present invention, a touch screen and a PC main body are integratedly formed without internal wiring therebetween. Such a configuration allows installation operation to be convenient, and also simplifies internal wiring of the control console, thereby improving accessibility. Thus, there is an advantage in maintenance in the field.

Also, the user interface of the HMI unit according to the present invention is divided into one area for displaying in real-time an operation status of the fuel handling system, and another area for displaying a touch menu allowing functions of the fuel handling system to be performed. In other words, through two areas displayed on one screen, it is possible to effectively perform a specific function through touch menu selection and at the same time to watch the status of the fuel handling system without switching a screen.

### BRIEF DESCRIPTION OF THE DRAWINGS

The above and other objects, features and advantages of the present invention will be more apparent from the following detailed description taken in conjunction with the accompanying drawings, in which:

FIG. 1 is a plan view illustrating a fuel handling system within a conventional reactor building;

FIG. 2 is a plan view illustrating a fuel handling system within a conventional nuclear fuel building;

FIG. 3 is a plan view illustrating a fuel handling system within a reactor building according to the present invention;

FIG. 4 is a view illustrating the configuration of a control system according to the present invention;

FIG. 5 is a view illustrating a main operation screen of a refueling machine;

FIG. 6 is a view illustrating an upender area enlargement screen of a refueling machine;

FIG. 7 is a view illustrating an operation information screen of a fuel transfer system (FTS) of a refueling machine;

FIG. 8 is a view illustrating a hoist operation screen of a refueling machine;

FIG. 9 is a view illustrating a failure list screen of a refueling machine;

FIG. 10 is a view illustrating a reactor core loading status of a refueling machine;

FIG. 11 is a plan view illustrating a fuel handling system within a reactor building according to the present invention;

FIG. 12 is a view illustrating a main operation screen of a spent fuel handling machine;

FIG. 13 is a view illustrating a hoist operation screen of a spent fuel handling machine;

FIG. 14 is a view illustrating a failure information screen of a spent fuel handling machine;

FIG. 15 is a view illustrating an entire rack status management screen of a spent fuel handling machine;

FIG. 16 is a view illustrating a status management screen of a specific rack of a spent fuel handling machine;

FIG. 17 is a view illustrating a fuel transfer sequence screen of a spent fuel handling machine; and

FIG. 18 is a view illustrating a failure history screen of a spent fuel handling machine.

### DETAILED DESCRIPTION OF THE EXEMPLARY EMBODIMENTS

Hereinafter, an exemplary embodiment of the present invention will be described in detail with reference to the accompanying drawings.

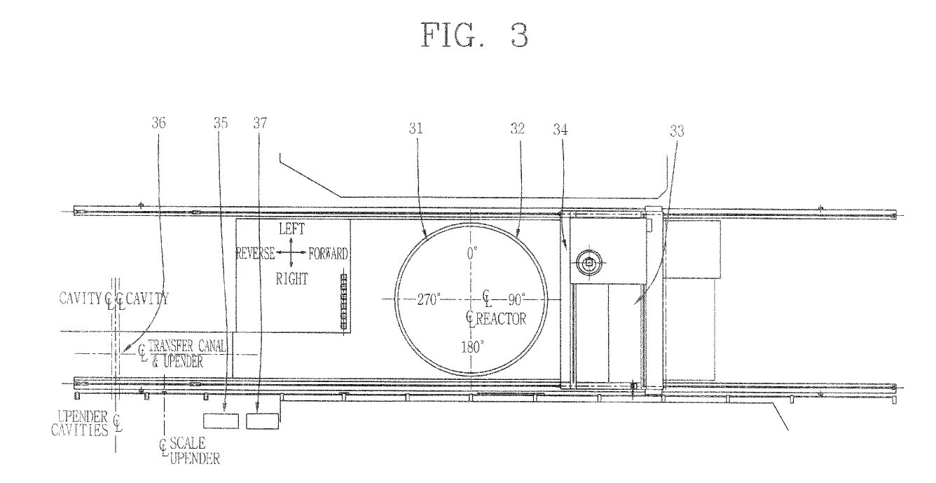

FIG. 3 is an arrangement view illustrating a refueling machine and a fueling machine control device in a reactor building according to the present invention.

As shown, a system within a reactor building according to the present invention includes a reactor 31, a reactor pool 32, a refueling machine 33, a refueling machine trolley 34, a refueling machine control console 35, a fuel transfer system (FTS) 36, and a FTS control console 37. According to the present invention, the refueling machine control console 35 is provided in a safe operation floor, instead of in the trolley 34 of the refueling machine 33, so as to operate the refueling machine.

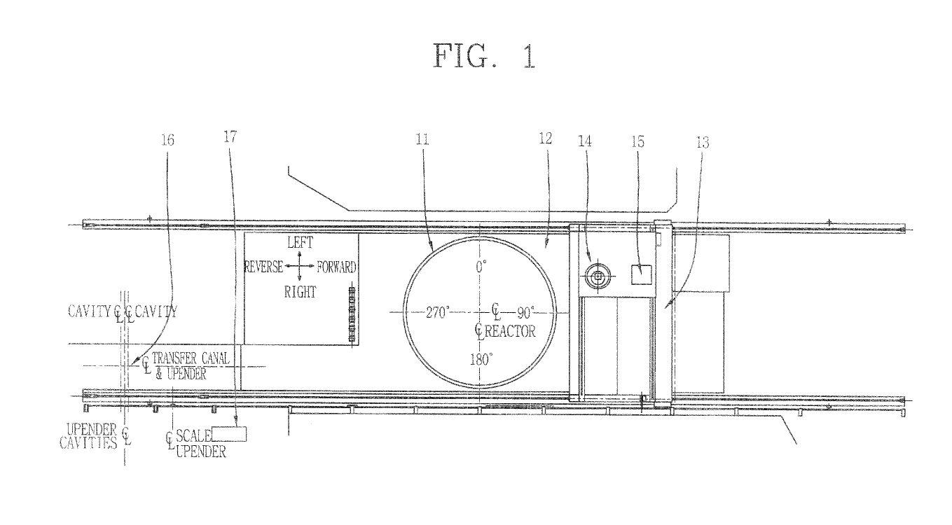

In other words, unlike a conventional technology (see FIG. 1) having the refueling machine control console 14 provided in the trolley 15 of the refueling machine 13, in the present invention, the refueling machine control console 35 is provided at the lateral side of the reactor pool 32, instead of above the reactor 31, so that high radioactivity emanating from the upper side of the reactor 31 can have a minimized affect on an operator.

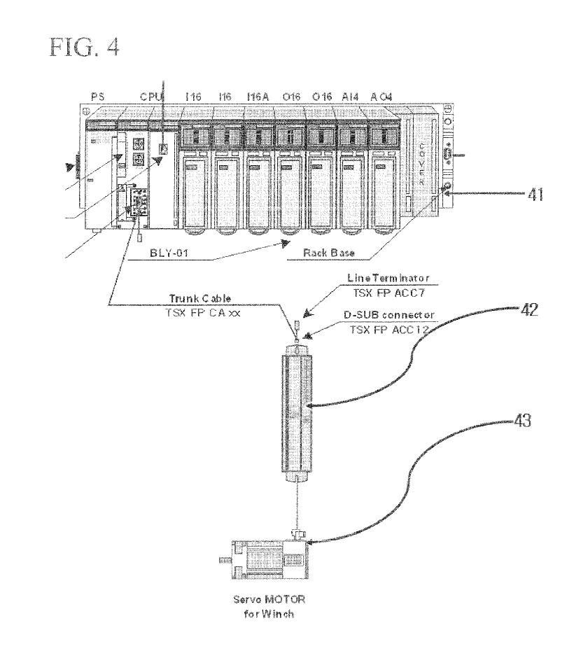

As shown in FIG. 4, the refueling machine control console 35, which has been newly developed for remote control, includes an automatic calculation part or a programmable logic controller (PLC) unit 41, a servo motor drive 42, a servo motor 43, and a human-machine interface (HMI) unit (or human-machine linkage system unit, not shown).

The PLC unit 41 provides a control logic for operation to the refueling machine 33, and transmits a signal for driving the refueling machine 33. The PLC unit 41 provides a linkage control logic on hardware of electric instrument parts, and machine operation for the safe transfer of nuclear fuel, a linkage control logic between fuel transfer devices, and a linkage control logic for collision prevention of devices within a reactor pool.

The servo motor drive 42 supplies driving power to the servo motor 43 for driving the fuel handling system and controls a speed by receiving a signal from the PLC unit 41.

The HMI unit (not shown), which is disposed in a remote location from the refueling machine 33, provides a user interface so that an operation status of the refueling machine 33 can be displayed based on a sensor's signal received from the PLC unit 41, and a signal input from an operator can be transferred to the PLC unit 41. The HMI unit provides a screen of a human machine interface system on a machine in the reactor so that the operator even in a remote location can maintain the same sense as that of operation above the refueling machine trolley 34.

Hereinafter, respective components will be described in detail.

A. Control Device Components

(1) PLC Unit 41

The PLC unit 41 provides a control logic for operation to the refueling machine 33, and transmits a signal for driving the refueling machine 33. The PLC unit 41 provides a linkage control logic on hardware of electric instrument parts, and machine operation for safe transfer of nuclear fuel, a linkage control logic between fuel transfer devices, and a linkage control logic for collision prevention of devices within a reactor pool.

In order to realize an operation logic of the refueling machine 33, the PLC unit 41 according to the present invention has advantages as described below.

PLC module scalability

high capacity CPU memory

high speed CPU processing speed (scan rate)

flexible input/output scalability through Fieldbus communication

Respective modules constituting the PLC unit 41 have functions as described below.

Power supply module: supplies power required for the PLC through conversion of AC input power into DC power

CPU: performs a calculation function of a control logic

communication module: exchanges information with peripheral devices

input module: receives signals input from various kinds of sensors

output module: transmits signals to peripheral actuators

Table 1 is one embodiment of a specification of the PLC unit according to the present invention.

TABLE 1
[specification of PLC]

| No | Index | Applied product | advantage |
|---|---|---|---|
| 1 | PLC name | Modicon Premium | |
| 2 | Type of | TSX P57 4634M | |
| | Processors | | |
| 3 | Operating | 0 . . . +60(+5 . . . according | |
| | Temperature | to IEC 1131-2), | |
| | | 0 . . . +70 with TSX FAN | |
| | | fan modules | |
| 4 | Number of | 4/6/8 slots 1612 slots 8 | High |
| | racks | | scalability |
| 5 | Discrete I/O | in-rack: 2048 | |
| | | Fieldbus: 14114 | |
| 6 | Memory | Program: 2048 Kbytes | High capacity |
| | capacity | Data: 440 Kbytes | memory, memory |
| | | | scalability |
| 7 | Communications | Integrated Uni- | |
| | | Telway(terminal port) | |
| | | Fipio bus manager | |
| | | (integrated)Integrated | |
| | | Ethernet: 10BASE-T/ | |
| | | 100BASE-TX | |
| 8 | Typical Scan | 0.048~0.057 ms per 1K of | High speed |
| | Rate | logic(boolean contacts) | Scan |

(2) Servo Motor Drive 42

The servo motor drive 42 supplies driving power to the servo motor 43 for driving the fuel handling system and controls a speed by receiving a signal from the PLC unit 41.

In order to supply servo motor driving power of the developed remotely controlled refueling machine 33, and to control the speed, the servo motor drive 42 is directly in charge of driving control of the refueling machine 33 based on operation instruction through communication with the PLC unit 41.

Table 2 is one embodiment of a specification of the servo motor drive 42 according to the present invention.

TABLE 2
[specification of servo motor drive]

| no | index | Specification of applied product | Advantage |
|---|---|---|---|
| 1 | Drive | Flex + DriveII | |
| | (trademark) | | |
| 2 | Type of | Hoist, Bridge: FPH4A20TR-EN23 | |
| | drives | Trolley: FPH4A15TR-EN23 | |
| | | Mast: FPH4A05TB-EN23 | |
| 3 | Power | 230-460 VAC 3Φ 50/60 Hz | |
| | supply | | |
| 4 | Feedback | 14 bit Resolver Incremental Encoder, | |
| | Type | Absolute Encoder | |
| 5 | Discrete | 8 Opto-isolated (10-30 VDC) | |
| | Input | PNP + Drive Enable | |
| | | Programmable logic | |
| | | via software | |
| 6 | Discrete | 3 Opto-isolated 24 V PNP. | |
| | Output | Software configurable | |
| 7 | Analog | 1 Assignable, 14 bit Resolutions | |
| | Input | | |
| 8 | Communication | Serial RS-232/RS-485Option: CAN | Various |
| | | open, Device Net, Profibus DP | Field Bus |
| | | | provided |
| 9 | Temperature | Operation: 0 to 40′ C. | |
| | | Storage: −25 to 70′ C. | |
| 10 | Shock | 10G according to DIN | |
| | | IEC 68-2-6/29 | |
| 11 | Vibration | 1G, 10-150 Hz, according to | |
| | | DIN IEC 68-2-6/29 | |
| 12 | Humidity | 10-90% non-condensing according | |
| | | to DIN40 O40/IEC144 | |
| 13 | Programming | Available (Speed & Position control), | |
| | | Program size 64 kB | |

(3) Servo Motor 43

The servo motor 43 drives the refueling machine 33. According to the present invention, a speed feedback device of the servo motor 43 for the remotely controlled refueling machine 33 employs a resolver with a high signal level so as to achieve high durability against a noise.

Also, unlike in a refueling machine for a national nuclear power plant in operation, in the remotely controlled refueling machine 33, a mast for the refueling machine and a winch for a nuclear fuel transfer device employ a servo motor and a servo motor drive, which enable more detailed control and thus improve reliability of the refueling machine. Thus, remote control can be appropriately carried out.

(4) HMI Unit

The HMI unit (or Man-Machine Interface, not shown), which is disposed in a remote location from the refueling machine 33, provides a user interface so that an operation status of the refueling machine 33 can be displayed based on a sensor's signal received from the PLC unit 41, and a signal input from an operator can be transferred to the PLC unit 41. The HMI unit provides a screen of a human machine interface system on a machine in the reactor so that the operator even in a remote location can maintain the same sense as that of operation above the refueling machine trolley 34.

Preferably, the HMI unit according to the present invention is realized in such a manner that a user's operation can be performed through a touch screen. Through the operation via the touch screen, an operator can make an operation instruction according to an automatic operation process. Thus, it is possible to simply carry out an operation, and to quickly obtain nuclear fuel transfer information.

Also, the HMI unit according to the present invention may include a touch screen and a PC main body (a calculation part for driving the HMI unit), in which they are integratedly formed without internal wiring therebetween. In other words, the touch screen and the PC main body are integratedly attached to each other, thereby eliminating internal wiring between them. Such a configuration as described above allows installation operation to be convenient, and also simplifies internal wiring of the control console, thereby improving accessibility. Thus, there is an advantage in maintenance in the field.

Table 3 below is one embodiment of a specification employing the HMI device according to the present invention.

TABLE 3
[specification of HMI device]

| | | Applied | |
|---|---|---|---|
| No | index | specification | advantage |
| 1 | TYPE OF MMI | Industrial Panel PC | |
| 2 | TYPE OF MODEL | IPPC-9171G | |
| 3 | Display Device | TFT color LCD | |
| 4 | Supported OS | MS-DOS, Windows | |
| | | 95/98/NT/2000/XP, Linux | |
| 5 | CPU | Socket 478, Intel | High speed |
| | | Pentium 4 up to 2.8 GHz | CPU |
| | | Intel Celeron up to 2.5 GHz | |
| | | (400/533 MHz) | |
| 6 | Main Memory | Two 184pin DDR DIMM | High capacity |
| | | sockets supports up to | Memory |
| | | 2 GB | |
| 7 | Expansion Slots | 2 X low-profile PCI | Easy |
| | | | scalability |
| 8 | Interfaces | COMx2, USB(Ver.2.0)x4, | |
| | | LAN(10/100Base- | |
| | | T)x1PS/2x1, LPTx2, | |
| | | Sound, PCMCIA Type IIx2 | |
| 9 | Degree of protection | NEMA4/IP65 | |
| 10 | Humidity | 5-85% RH @ 40′ C. (non- | |
| | | condensing) | |
| 11 | Temperature | Operating: 0′ C. to 50′ C. | |
| | | Storage: −20′ C. to 60′ C. | |
| 12 | Vibration Protection | 5~500 Hz, 1 Grms | |
| | | random vibration | |
| | | (Operating) | |

B. Operation of Refueling Machine Control Console 35

In the refueling machine control console 35, the servo motor drive 42 performing a main function is connected in parallel to input power (e.g., 480 VAC, 3PH, 60 Hz). Also, the servo motor drive 42 for each motion (such as a hoist, a trolley, a bridge, and a mast) is provided with a separate individual circuit breaker (CB) for input power so that protection and maintenance can be separately and easily carried out.

The servo motor drive 42 for each motion does not share two or motions, and supplies one to one power to a servo motor, for each motion, thereby constructing an independent power system. Thus, even failure of one servo motor drive has no effect on other motions.

A speed feedback from the servo motor 43 is input to the servo motor drive 42 so that the speed of the servo motor 43 can be controlled through comparison with a speed command value from the PLC unit 41. Also, the servo motor drive 42 realizes a precise control while absorbing, through a resistor, regenerative power caused by a counter electromotive force generated by braking of the servo motor 43.

A power source for control and utility of the refueling machine control console 35 is supplied by using a separately controlled power transformer, in order to separate from a servo motor power source for supplying power to main control devices (such as a power source of the PLC unit 41, and a control power source of the servo motor drive 42). Thus, the power source can be isolated from ambient noise. Furthermore, a DC power source of the PLC unit 41 and a control power source of the servo motor drive 42 are doubly isolated through an AC-DC converter.

Also, in a power system for control and utility, respective feeders are connected through respective individual circuit breakers so that each of devices is configured independently from peripheral devices. This makes it possible to easily carry out maintenance.

C. Entire Configuration of a Control System

The configuration of a control system of a refueling machine is described below.

PLC System

Man-Machine Interface (MMI) System (or HMI System)

CCTV System

A PLC system for the refueling machine 33 and the fuel transfer system 36 has a bidirectional communication system constructed through Ethernet. As a communication medium, a fiber optic cable is used so as to eliminate an effect from ambient noise.

In the refueling machine control console 35 and the FTS control console 37, a video signal of a photographing device (such as a CCTV), and an audio signal of a paging system of the refueling machine control console 35 are transmitted, through Ethernet, to a supervisory console of a main control room of a nuclear power plant. Also, in consideration of installation locations of the refueling machine control console 35, the FTS control console 37, and the supervisory console, in order to inhibit a transmitted-signal's obstruction and diminution caused by a noise and a voltage drop in a long distance communication, an optical communication is used.

Each servo motor drive 42 allows rapid information exchange to be carried out through configuration of a system of a communication with the PLC unit 41 by using Profibus, as a kind of Fieldbus communication. Also, it realizes simple connection through minimization of connection, thereby providing ease of maintenance.

D. Main Operation Screen 1

Hereinafter, one embodiment of an operation screen and an operation information screen, provided from the HMI unit of the refueling machine control console 35 according to the present invention, will be described.

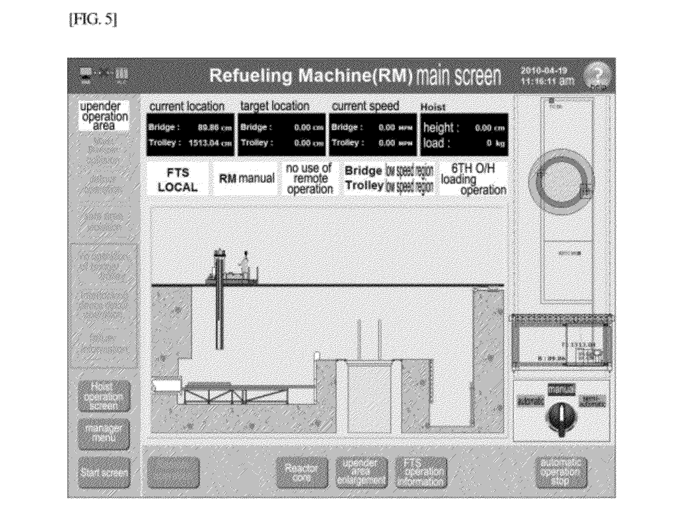

(1) Main Operation Screen of Refueling Machine 33 (see FIG. 5)

Referring to FIG. 5, a main operation screen of the refueling machine visually displays a movement status and a current location of the machine so that an operator even in a remote location can exactly know an operation state of the machine through the operation screen.

The screen includes a main screen in a center area and an auxiliary screen in a right area, and at the left side and the lower side of the screen, touch buttons for selecting various kinds of functions are provided.

The main operation screen can be accessed after an operator is logged in at a start screen and checks all items to be confirmed before operation. The main operation screen can be switched to a hoist operation screen or a manager menu. The main screen is shown whenever operation of a bridge or a trolley is required.

In the main screen, location information on a bridge and a trolley is shown. Through touch buttons displayed on the screen, a hoist operation screen, a manager menu, a start screen, remote operation, camera tilt, a reactor core, upender area enlargement, FTS operation information, and an operation mode selecting switch may be selected.

In the main screen in the center area, all information required for operation of a bridge and a trolley in a manual operation mode is displayed. When an automatic operation is executed, the main screen shows automatically operating motions.

The auxiliary screen in the right area of the display shows, in real-time, the motion of a machine and the center of a mast. The center of the mast flickers in red during the operation of the machine. At the start of automatic operation or semi-automatic operation, when a target location is appointed, the corresponding target location in the reactor core is indicated by a green square. When the machine comes into a core area (indicated by a concentric circle), the system automatically shows the location of the mast center, in the center of the screen. When the machine is located in the core area, pink squares move at both sides of a scale mark of the core in order to indicate a location change of a bridge and a trolley. When the machine moves out of the core area, the square indicating the center of the mast disappears from the core screen. Two squares at the right lower side of the auxiliary screen indicate the location of an upender cavity. One square at the center of the auxiliary screen indicates the location of a storage rack. In the auxiliary screen in the right area on the display, an area indicated by a point-dotted line surrounding the core (the concentric circle), the storage rack (one square in the center), and the upender cavity (two squares in the lower portion) indicates a safe area. The machine cannot move out of the safe area. If it is out of the safe area, it is possible to re-enter the safe area by activating a detour operation push button.

Hereinafter, functions of touch menu buttons displayed at the left side and the lower side of the main operation screen will be described.

A) No Operation of Bridge/Trolley

When conditions forbidding the operation of a bridge/a trolley occur, the button is turned on. Then, the button is selected, a screen showing operation forbidding conditions (e.g. in hoist operation, a low speed region of a hoist, etc.) is displayed.

B) Interlocking Device Detour Operation

A key selection switch of interlocking device detour operation of a control console is turned on through the selection of “On.” When the interlocking device detour operation is selected, a screen showing that forced operation is possible through a detour operation of interlocking devices is displayed. However, the corresponding operation state has to be determined by a manager and is used only for urgent operation since all interlocking devices are released.

C) Safe Area Violation

When violation of a safe area occurs, a screen showing a violation state of the safe area is displayed.

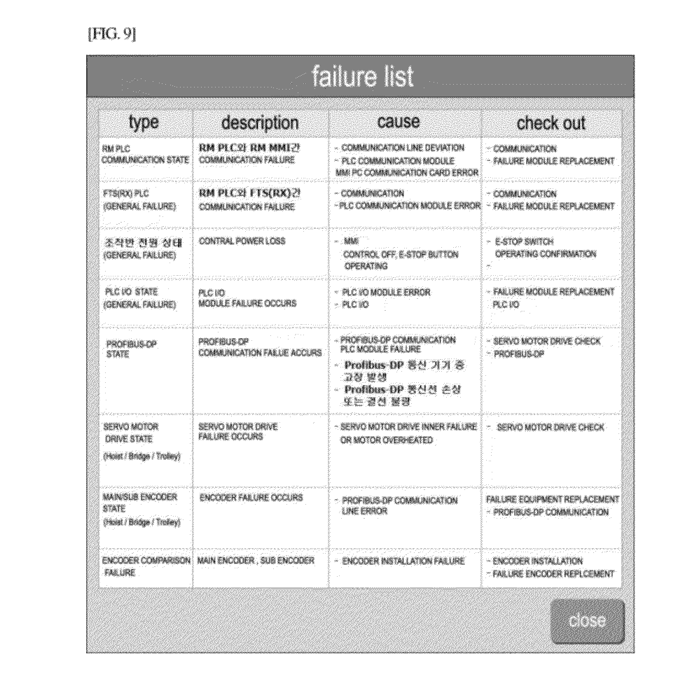

D) Failure Information (see FIG. 9)

When a system error is sensed, the button is turned on. Then, a failure information screen allowing a user to grasp and cope with the type of the error is displayed.

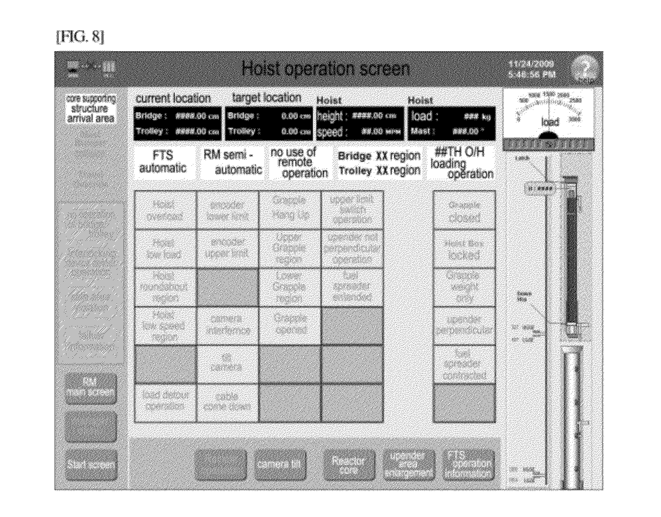

E) Hoist Operation Screen (see FIG. 8)

Through the selection of a button for switching an operation screen, a hoist operation screen is displayed. When automatic operation is finished, and hoist operation is performed, the hoist operation screen is automatically displayed.

F) Start Screen

Through the selection of a button for switching a screen, an MMI start screen for system log-in for machine operation or system log-out for operation termination is displayed.

G) Remote Operation

The button is activated in a remote operation mode. When the button is selected, a remote operation screen is displayed.

H) Camera Tilt

The button is used to tilt a camera. When the button is selected, the camera is tilted.

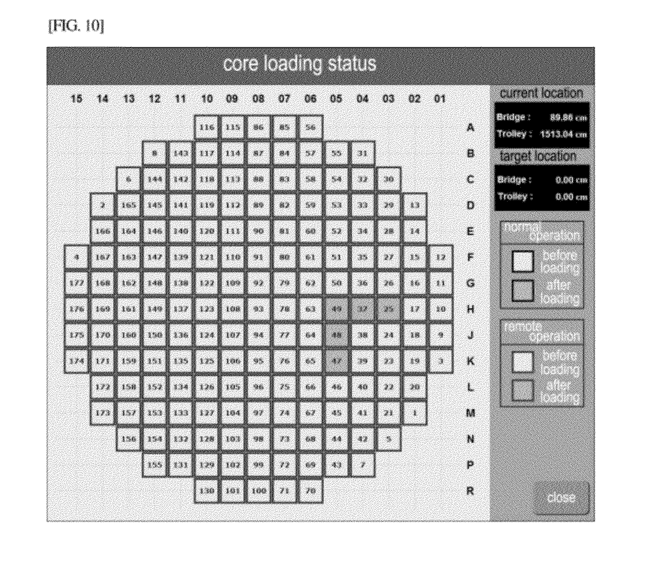

I) Reactor Core (see FIG. 10)

The button is used to display a core screen. Through the core screen, it is possible to check the status of fuel within the core. Also, when a machine enters a core area during operation, this button is automatically displayed, and on the other hand, when the machine is out of the core area, the button automatically disappears.

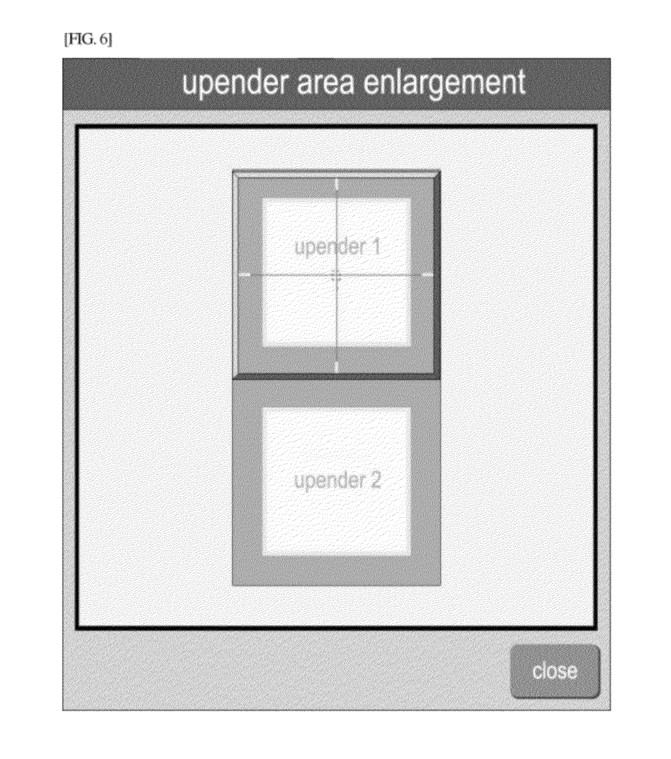

J) Upender Area Enlargement (see FIG. 6)

The button is used to display an enlarged screen of an upender area. It may be used to check in detail the center location of a mast during operation in an upender.

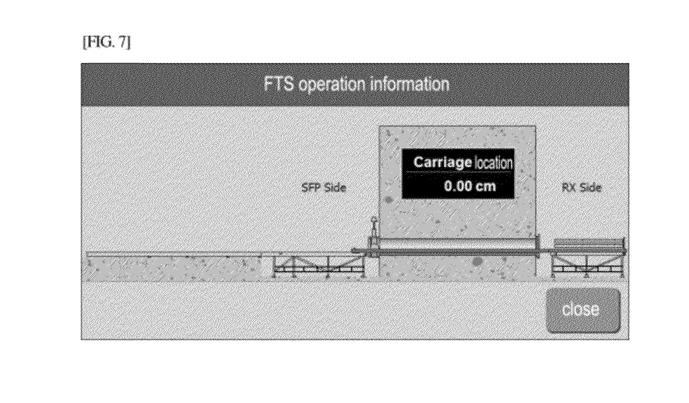

K) FTS Operation Information (see FIG. 7)

The button is used to display an operation information screen of an FTS at a reactor building's side. As required, it may be used to check the operation information of the FTS at the reactor building's side (that is, a linkage device of a refueling machine).

L) Operation Mode Selecting Switch

The selecting switch is used to change an operation mode of a machine, which is used to switch an operation mode into manual, automatic, and semi-automatic modes. When an automatic mode or a semi-automatic mode is selected, corresponding interlocking operations are checked in the PLC unit 41. When the interlocking operations are satisfied, an automatic/semi-automatic screen is displayed. When an operator attempts to manually carry out operation through an operation lever during automatic (semi-automatic) operation after selection of an automatic/semi-automatic mode, the automatic (semi-automatic) operation is stopped.

M) Automatic Operation Stop

The button is activated when automatic (semi-automatic) operation is initiated. When a user wants to stop automatic (semi-automatic) operation and selects the button, the machine is stopped. Then, when he wants to resume the automatic (semi-automatic) operation after the stopping of automatic operation, it is possible to resume the automatic (semi-automatic) operation by selecting the automatic (semi-automatic) mode of an operation mode selecting switch as long as the machine satisfies all of the linkage conditions for the automatic (semi-automatic) operation.

(2) Hoist Operation Screen (see FIG. 8)

In FIG. 8, a hoist operation screen is shown. The hoist operation screen is displayed when a hoist is operated through a joystick or a [Hoist operation screen] button on a main screen is touched. In the hoist operation screen, a graph showing a hoist height, a hoist load, and an interlocking state is displayed.

A current location, a previously selected location, a hoist load, and a hoist location are displayed in the upper portion of the screen. The hoist load is displayed together with an indication of overload or low load in an indicator at the right upper side according to a fuel selector switch. At the right side of the display, there is a screen showing the location and the load status of a hoist, and a value of a real-time height of the hoist is displayed within an oval-shaped box. The drawing of a fuel assembly within the hoist box shows raising or lowering of fuel within the hoist box.

An operation screen displays touch-sensitive buttons and status indicators when linkage conditions occur during the operation of a hoist. On the screen, there are a plurality of lamps and display indicators which provide normal and abnormal operation information of a machine during the operation of the hoist.

At the left side and the lower side in the hoist operation screen, touch menu buttons are provided. These buttons are displayed whenever interlocking conditions having an effect on the operation of a machine occur. They provide simple explanation to an operator, so that he can check the more detailed explanation on a corresponding interlocking operation by selecting a corresponding button.

Menu buttons of the hoist operation screen are provided in the same manner as those of the main screen of the refueling machine, and thus their detailed explanation is omitted.

(3) An Operation Button of a Failure Information Screen, and a Status Indicator (see FIG. 9)

As shown in FIG. 9, this screen is displayed when an operator touches a [failure information] button on the main screen of the refueling machine or the hoist screen. In this screen, a failure state of a machine is shown.

If there is no failure in the machine, the button is turned off, and on the other hand, if an error is sensed, a light lamp is turned on. In a state where a failure of an encoder occurs, when the operation is carried out after the release of the corresponding encoder, a red lamp flickers.

When a [failure information list] button is operated, real-time status on a currently occurring failure can be shown in detail. When the failure is repaired, it is possible to cancel the failure mode through operation of a [failure reset] button, and then to initiate the operation.

(4) Core Status Management (see FIG. 10)

As shown in FIG. 10, when a [core status management] icon is selected, a core loading status screen is displayed. A user can change the core status by directly clicking each cell or pressing a [load all] or [extract all] button.

The operation screen as described above makes it possible to sense the operation status of a machine in more detail even during remote operation than compared to operation at a position above a reactor. Also, since the operation is remotely performed, a servo motor is used for more detailed operation. Also, in an electric system, a power source circuit and a control circuit are isolated by using a control transformer so that stability of a control voltage can be secured against a surrounding condition such as a noise. Also, an individual circuit breaker for each connection is used, thereby achieving independence. This eliminates an affect caused by a single failure and provides ease of maintenance.

Also, a control system of a remotely controlled refueling machine includes high-performance components.

Also, a communication, such as Ethernet and Profibus-DP, is used so that data exchange can be quickly carried out. Furthermore, simplification of connection in a control system provides advantages in view of maintenance, and the utilization of an optical communication makes it possible to secure the safety of a data communication system.

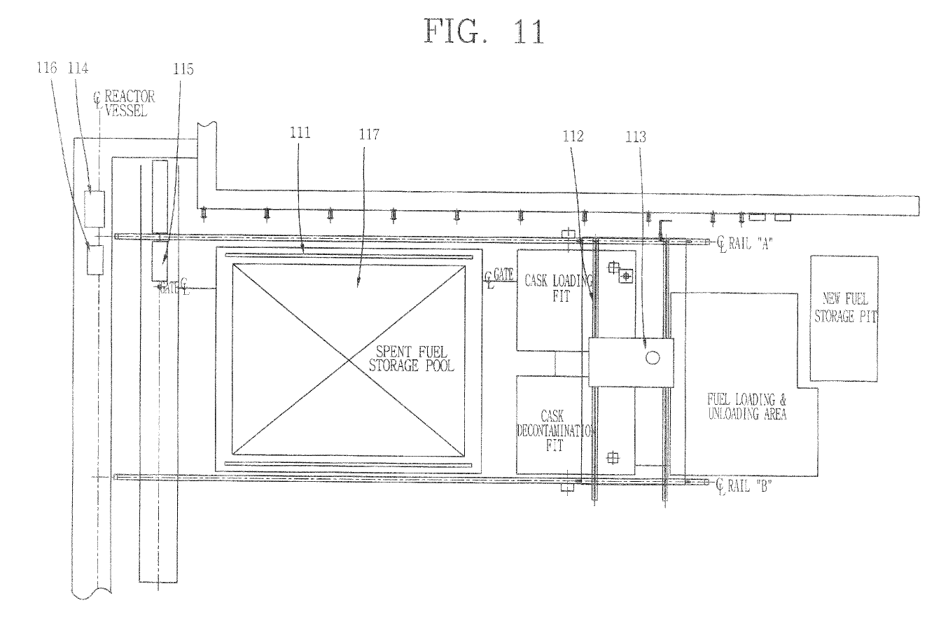

Hereinafter, a control target remote system of a spent fuel handling machine of a nuclear power plant will be described with reference to FIG. 11.

FIG. 11 is a plan view illustrating a fuel handling system within a nuclear fuel building of a nuclear power plant.

As shown, the fuel handling system within the nuclear fuel building includes a spent fuel storage rack 111, a spent fuel handling machine (SFHM) 112, an SFHM trolley 113, an SFHM control console 114, a fuel transfer system (FTS) 115, an FTS control console 116, and a spent fuel storage pool 117.

The SFHM trolley 113 is operated above the spent fuel storage rack 111 in the fuel handling system within the nuclear fuel building, by which new fuel is loaded to the FTS 115 and is transferred to a reactor building, and spent fuel transferred from the reactor building by the FTS 115 is extracted and transferred/loaded to the spent fuel storage rack 111.

According to the present invention, the SFHM control console 114 is provided in a safe operation floor, instead of above the SFHM trolley 113, so that the machine can be operated in the place.

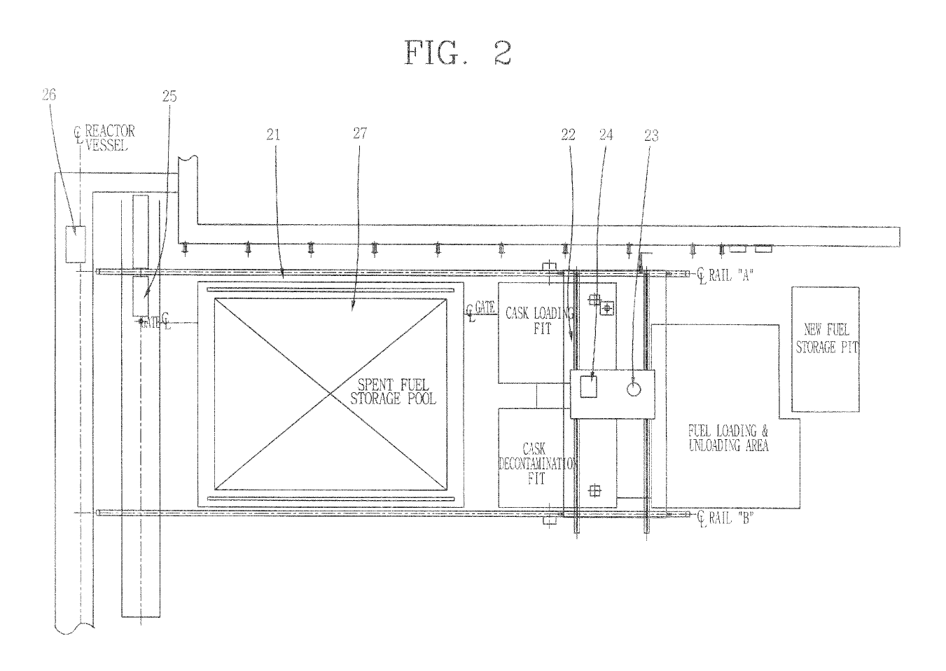

In other words, in a conventional technology (see FIG. 2), the SFHM control console 24 is provided in the SFHM trolley 23, while in the present invention, the SFHM control console 114 is provided at the lateral side of the spent fuel storage pool 117 instead of above the spent fuel storage rack 111. Thus, high radioactivity emanating from the upper side of the spent fuel storage rack 111 can have a minimized affect on an operator.

Also, the SFHM control console 114 according to the present invention includes a PLC unit and an HMI unit. The PLC unit provides a linkage control logic on hardware of electric instrument parts newly developed for remote control, and machine operation for the safe transfer of nuclear fuel, a linkage control logic between fuel transfer devices, and a linkage control logic for collision prevention of devices within a reactor pool. The HMI unit provides a user interface in such a manner that a signal input from an operator can be transferred to the PLC unit 41. The HMI unit provides a screen of a human machine interface system so that the operator even in a remote location can maintain the same sense as that of operation above the trolley of the SFHM 112.

In the spent fuel handling machine, hardware of electric instrument parts and devices used for control logic are the same or similar to those of a refueling machine of a reactor building. Thus, their explanation is omitted in this specification. Hereinafter, only an MMI screen which is different from that of a refueling machine will be described.

E. Main Operation Screen 2

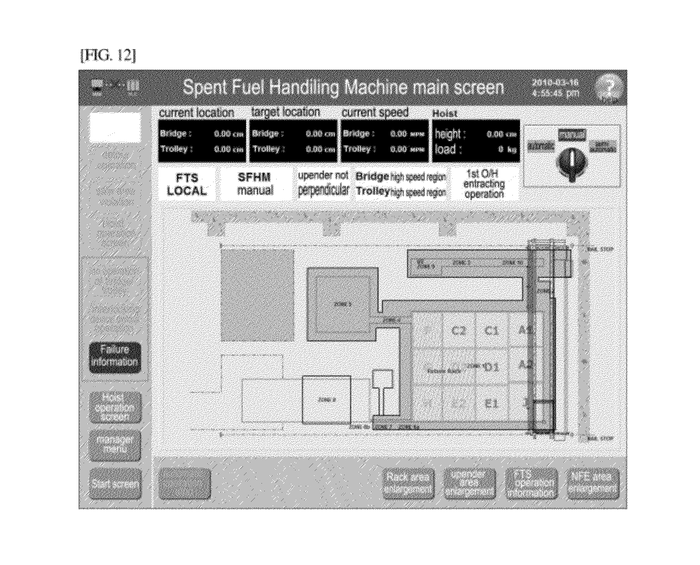

(1) Main Operation Screen (see FIG. 12)

The main operation screen can be accessed after an operator is logged in at a start screen and checks all items to be confirmed before operation. The main operation screen can be switched to a hoist operation screen or a manager menu. The main screen is shown whenever operation of a bridge or a trolley is required.

In the main screen, location information on a bridge and a trolley is shown. Also, at the left side and the lower side, touch buttons (a hoist operation screen, a manager menu, a start screen, rack enlargement, upender area enlargement, FTS operation information, new fuel elevator operation information, and an operation mode selecting switch) are provided so that the corresponding functions can be selected.

In the main screen, all information required for operating a bridge and a trolley in a manual operation mode is shown. When an automatic operation is executed, the main screen shows automatically operating motions. The center area of the display shows in real-time the motion of a machine and the center of a hoist. The center of the hoist flickers in red during the operation of the machine. At the start of automatic operation or semi-automatic operation, when a target location is appointed, the corresponding target location in the operation area of the screen is indicated by a green square. When the machine comes into a spent fuel storage pool, the system automatically displays an enlargement screen of a corresponding rack at the center of the screen. At both sides of each cell scale, pink squares indicating location changes of a bridge and a trolley flicker, and a red square indicating a location of the center of the hoist flickers.

When a machine moves out of an area of the spent fuel storage pool, the square indicating the center of the hoist disappears from the rack enlargement screen. Two squares at the right upper side of the screen indicate the location of an upender cavity. One square at left upper side of the screen indicates a cask cavity, and one square at the center lower side of the screen indicates the location of a new fuel elevator. An area indicated by a point-dotted line surrounding the spent fuel storage pool, the upender cavity, and the cask cavity indicates a safe area. The machine cannot move out of the safe area. If it is out of the safe area, it is possible to re-enter the safe area by using a travel detour operation push button.

The screen provides entire information on the operation status of a spent fuel handling machine, which is mainly used for operating a trolley/a bridge. Also, it is a main screen for operating the spent fuel handling machine, which can initiate automatic/semi-automatic operation.

At the left side of the main screen, touch-sensitive status buttons are provided. These buttons are displayed whenever an interlocking condition having an effect on the operation of a machine occurs. Some of the interlocking operation buttons are displayed when the machine is normally operated. These show simple explanations on the occurring interlocking operations to an operator. The operator can select a button for displaying more specific explanation on the interlocking operations. Hereinafter, these buttons will be described.

A) Interlocking Device Detour Operation

A key switch of interlocking device detour operation of a control console is turned on through the selection of “On.” At the same time, a screen showing that forced operation is possible through a detour operation of the interlocking device is displayed. However, the corresponding operation state has to be determined by a manager and has to be used with care only for urgent operation since all interlocking devices are released.

B) Failure Information

When a system error is sensed, the button is turned on. Then, when the button is selected, a failure screen allowing a user to grasp and cope with the type of the error is displayed.

C) Hoist Operation Screen

Through the selection of a button for switching an operation screen, a hoist operation screen is displayed. When automatic operation is finished and a hoist is operated, the hoist operation screen is automatically displayed.

D) Rack Enlargement

The button is used to display a rack screen. Through a rack enlargement screen, it is possible to check the status of fuel in cells of each rack. Also, when a machine in operation enters an area of a spent fuel handling storage pool, the screen automatically appears, while when the machine is out of the area, the screen automatically disappears.

E) Upender Area Enlargement

The button is used to display an enlarged screen of an upender area. It may be used to check in detail the center location of a hoist during operation in an upender.

F) FTS Operation Information

The button is used to display an operation information screen of an FTS at the spent fuel storage pool 117's side. As required, it may be used to check the operation information of the FTS at the spent fuel storage pool 117's side (that is, a linkage device of a spent fuel handling machine).

G) New Fuel Elevator Operation Information

The button is used to display a screen of operation information of a new fuel elevator (NFE).

H) Operation Mode Selecting Switch

The selecting switch is used to change an operation mode of a machine, which is used to switch an operation mode into manual, automatic, and semi-automatic modes. When an automatic mode or a semi-automatic mode is selected, corresponding interlocking operations are checked in the PLC unit. When the interlocking operations are satisfied, an automatic/semi-automatic screen is displayed. When an operator attempts to manually carry out operation through an operation lever during automatic (semi-automatic) operation after selection of an automatic/semi-automatic mode, the automatic (semi-automatic) operation is stopped.

I) Communication State Indicator

The indicator at the left upper side is to indicate the communication state between an MMI unit and a PLC unit. When the communication between the MMI unit and the PLC unit is normally performed, data flow is displayed, while when the communication is interrupted, the interruption of the communication is displayed through an image.

J) Detour Operation

This indicator flickers, in a state where a machine is out of a safe area, when the machine is operated by pressing a travel detour operation push button in the control panel at the left side so as to carry out detour operation.

K) Safe Area Violation

The button is turned on when a machine is out of a safe operation area. When the button is selected, a screen showing a violation state of the safe area of the corresponding operation is displayed.

L) FTS Remote/Local

The indicator indicates an operation mode of an FTS. When the operation mode selecting switch of an FTS is set as Remote Auto, the indicator displays “FTS Remote,” while when the switch is set as Local Auto or Local Manual, the indicator displays “FTS Local.” Only when FTS Remote is displayed, automatic operation of the FTS in the spent fuel handling machine can be initiated. On the other hand, when FTS Local is displayed, the operation of the FTS can be carried out in the FTS control console.

M) Bridge/Trolley Operation Speed Region Indicator

The indicator indicates a possible region of an operation speed of a bridge/a trolley at a current location where the SFHM 112 is located. When the bridge or the trolley is in a low speed region, the corresponding operation is limited to a low speed.

N) Preventive Maintenance Count, Load/Extraction Operation Indicator

The indicator indicates a preventive maintenance count, and load/extraction operation through an operation screen when a manager inputs a transfer sequence in a manager menu while inputting a corresponding preventive maintenance count and a load/extraction sequence according to a predetermined mechanism.

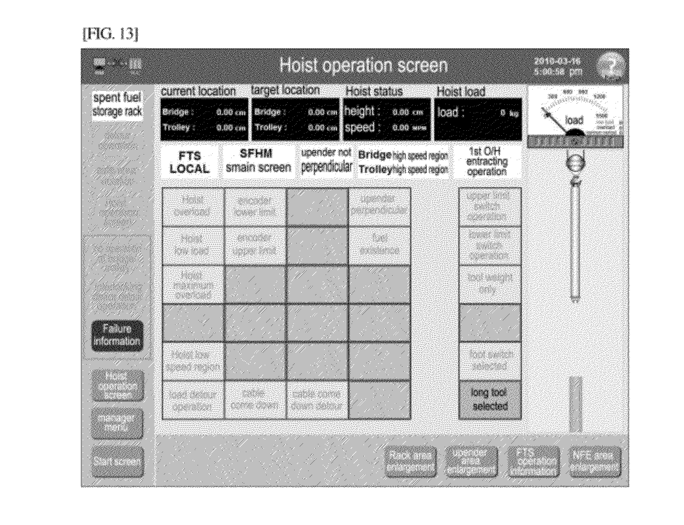

(2) Hoist Operation Screen (see FIG. 13)

The hoist screen is displayed when a hoist is operated through a joystick or a [Hoist operation screen] button on a main screen is touched. In the hoist operation screen, a graph showing a hoist height, a hoist load, and an interlocking state is displayed.

A current location, a previously selected location, a hoist load, and a hoist location are displayed in the upper portion of the screen. The hoist load is displayed together with indication of overload or low load in an indicator at the right upper side according to a fuel selector switch.

At the right side of the screen, there is a screen showing the location and the load status of a hoist, and a value of a real-time height of the hoist is displayed.

A) Configuration of a Hoist Operation Screen

On the hoist operation screen, buttons and status indicators are shown when interlocking conditions occur during operation of a hoist. There are a plurality of lamps and indicators which provide normal and abnormal operation information of a machine during operation of the hoist.

B) Main Operation Buttons of a Hoist Operation Screen

At the left side of the hoist operation screen, buttons are provided. These buttons appear whenever interlocking conditions having an effect on the operation of a machine occur. They provide simple explanation to an operator, so that he can check the more detailed explanation on corresponding interlocking operations by selecting the corresponding button.

C) Status Indicators of a Hoist Operation Screen

In the hoist operation screen, status indicators related to hoist operation are provided in the same manner as those in the main screen of the spent fuel handling machine.

Status indicators around the hoist operation screen are almost the same as those in the main screen of the spent fuel handling machine, and thus their explanation may refer to the status indicators in the main screen of the spent fuel handling machine.

D) Hoist Status Indicator

The indicator displays a current height and an operation speed of a hoist

E) Hoist Load Indicator

The indicator displays a current value of load added to a hoist.

F) Hoist Load Indicator

A current load added to a hoist is displayed in a graphic in the indicator, and setting values of overload and maximum overload are displayed in the scale mark. Thus, it is possible to compare the current load to the overload setting value.

G) Animation Display Window on Hoist Operation Status

At the left side of the screen, drop/rise operation status of a hoist is displayed in real-time in the animation. Also, through the animation, it is possible to instinctively separate hoist operation in an area of the spent fuel storage pool, from hoist operation in an area of an upender, a cask, and a new fuel elevator. Also, a real-time height of a hoist is displayed in animation so that a set height in each area can be checked.

H) Hoist Operation Status Lamp

In the hoist operation screen, indicating lamps related to hoist operation are shown at the center of the screen. Lamps indicating a normal operation status are shown at the right side, and lamps indicating an abnormal operation status requiring attention are shown at the left side.

I) Hoist Low Speed Region

When a hoist enters a set hoist low speed region, the lamp is turned on in yellow. Also, when the hoist is out of a hoist low speed region, the lamp is turned off.

J) Load Detour Operation

When a hoist is operated in a load roundabout region and a load roundabout condition, the lamp is turned on in red. On the other hand, when the hoist is out of the above mentioned condition, the lamp is turned off.

K) Sense of Encoder Upper Limit

When a hoist height transferred from an encoder reaches a hoist uppermost height set in the PLC, the lamp is turned on in red.

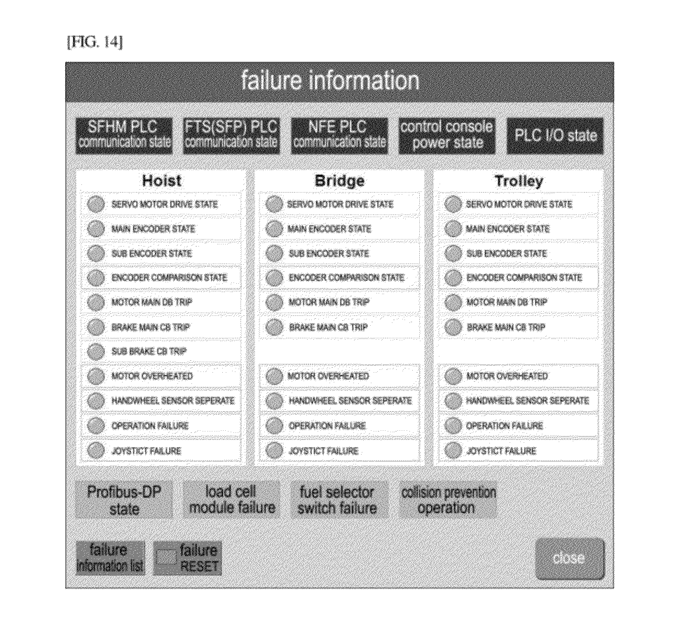

(3) Failure Information Screen (see FIG. 14)

In FIG. 14, a failure information screen is displayed. When an operation failure occurs, a failure information button on an operation screen is turned on in red. Then, a screen displayed through the selection of the failure information button provides status information of a currently occurring failure to a user.

This screen is displayed when an operator touches a [failure information] button on the main operation screen of the spent fuel handling machine or the hoist screen. In this screen, a failure state of a machine is shown.

If there is no failure in the machine, the button is turned off, and on the other hand, if an error is sensed, a light lamp is turned on. In a state where a failure of an encoder occurs, when the operation is carried out after release of the corresponding encoder, a red lamp flickers.

When a [failure information list] button is operated, real-time status on a currently occurring failure can be shown in detail. When the failure is repaired, it is possible to cancel the failure mode through operation of a [failure reset] button, and then to initiate the operation.

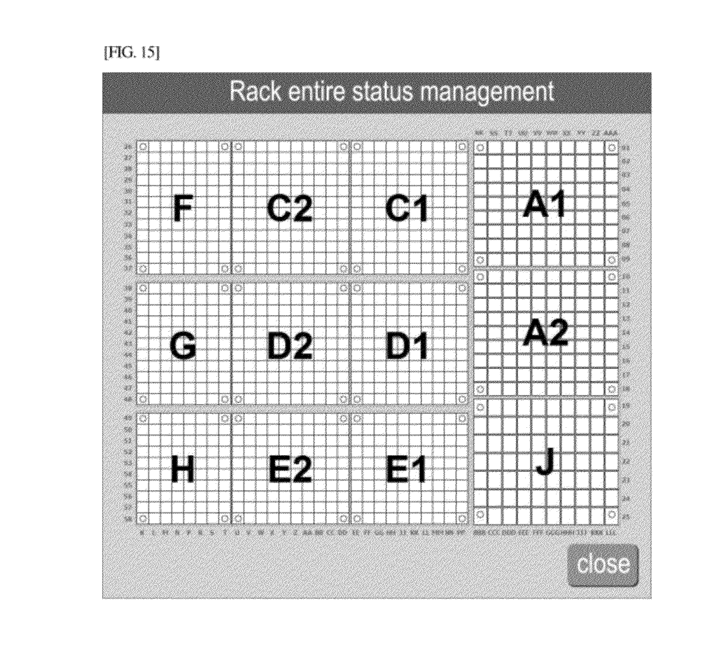

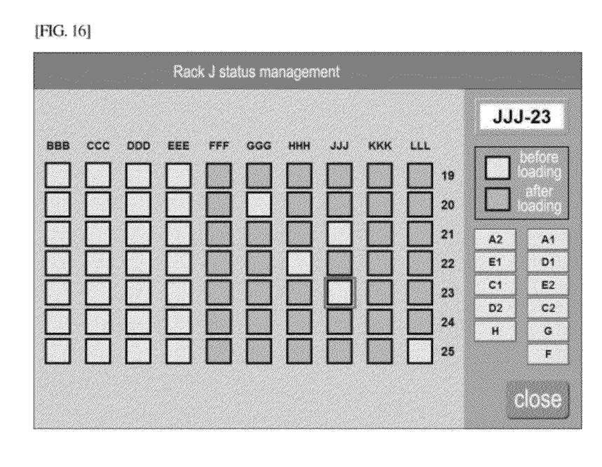

(4) Rack Status Management (see FIGS. 15 and 16)

In FIG. 15, a status management screen of all racks is shown, and in FIG. 16, a management screen of a specific rack, for example, rack J, is shown.

When a [rack status management] button is pressed, a screen of a spent fuel storage pool area is displayed (see FIG. 15). A user can select a required rack. When the required rack is selected, a screen of a corresponding rack map is displayed (see FIG. 16). By pressing each cell, it is possible to change a loading status of fuel into a before/after loading mode.

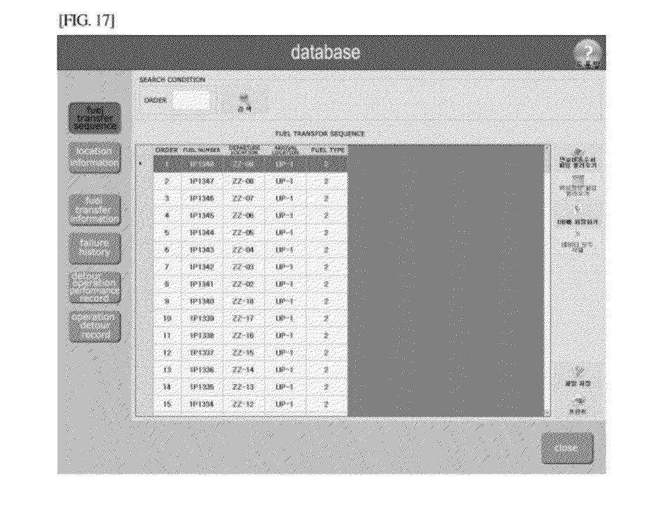

(5) Database Management (see FIG. 17)

In FIG. 17, in a database management screen, one example of a fuel transfer sequence is displayed. When a [database management] button is selected in a [management menu] screen, a database management screen is displayed. In this screen, an operator can access files and recordings stored in the database, and also can load a new sequence file while deleting recorded data. By selecting a [close] button, the operator can return to the previously displayed [management menu] screen.

This icon allows the user to check the last input general file data.

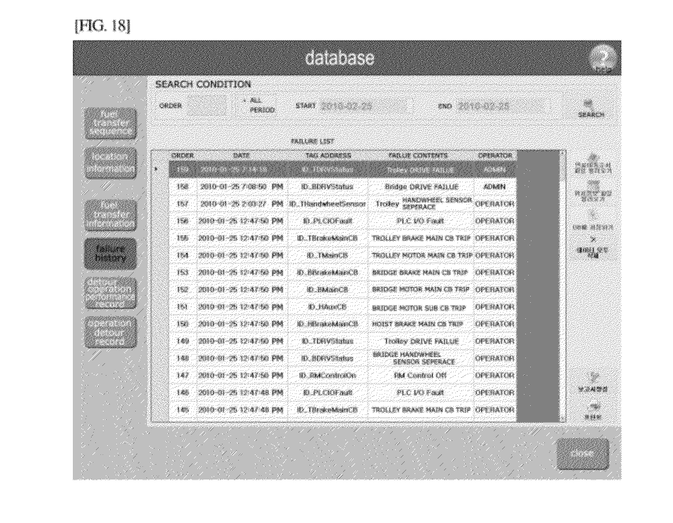

(6) Failure History Screen (see FIG. 18)

In FIG. 18, an example of a failure history screen is shown. In this screen, a history of a failure occurring during operation of a spent fuel handling machine can be recorded. Thus, information on a failure (such as type, time, and operator in-charge) is provided.

As described above, a specific embodiment of the present invention has been described. However, those skilled in the art will understand that the spirit and scope of the present invention are not limited to such a specific embodiment, and various changes and modifications are possible without departing from the spirit of the present invention.

Accordingly, the above described embodiments are provided so that those skilled in the art can completely understand the scope of the invention. Thus, it should be understood that the embodiments are illustrative only, and not limiting in any way, and the present invention is defined within the scope of the appended claims.

What is claimed is:

1. A remote control system for a fuel handling system of a nuclear power plant, the remote control system comprising a remote control console for controlling the fuel handling system in a remote location,
wherein the remote control console comprises:
a programmable logic controller (PLC) unit which provides a control logic for operation to the fuel handling system, receives a signal input from a sensor provided in the fuel handling system, and transmits a signal for driving the fuel handling system;
a servo motor drive which supplies driving power to a servo motor for driving the fuel handling system and controls a speed by receiving a signal from the PLC unit; and
a human-machine interface (HMI) unit disposed in a remote location from the fuel handling system, provides a user interface so that an operation status of the fuel handling system is displayed based on the sensor's signal received from the PLC unit, and a signal input from an operator is transferred to the PLC unit.

2. The remote control system as claimed in claim 1, wherein the fuel handling system comprises a reactor, a reactor pool, a fuel transfer system (FTS), and a refueling machine which loads new fuel to the reactor, extracts and transfers spent fuel to the FTS,
wherein the remote control console is provided at a lateral side of the reactor pool, instead of above the reactor.

3. The remote control system as claimed in claim 1, wherein the fuel handling system comprises a spent fuel storage rack, a spent fuel storage pool, an FTS, and a spent fuel handling machine which extracts spent fuel from the FTS, and transfers and loads the spent fuel to the spent fuel storage rack,
wherein the remote control console is provided at a lateral side of the spent fuel storage pool, instead of above the spent fuel storage rack.

4. The remote control system as claimed in claim 1, wherein the PLC unit stores the operator's input command value of a location (or a speed) of the fuel handling system, generates in real-time a signal required to reach the command value by comparing the command value to the fuel handling system's location (or speed)'s value detected in real-time from the sensor provided in the fuel handling system, and transfers the signal to the servo motor drive.

5. The remote control system as claimed in claim 1, further comprising a photographing device which photographs in real-time a state where a fuel grapple grapples fuel in the fuel handling system, and provides the photographed state by an image signal to the HMI unit so that the HMI unit displays in real-time the state where the fuel grapple grapples the fuel.

6. The remote control system as claimed in claim 1, wherein the user interface of the HMI unit is operated through a touch screen, and the touch screen and a calculation part for driving the HMI unit are integratedly formed without internal wiring therebetween.

7. The remote control system as claimed in claim 1, wherein the user interface of the HMI unit is divided into one area for displaying in real-time an operation status of the fuel handling system, and another area for displaying a touch menu allowing functions of the fuel handling system to be performed.
